(19) United States
(12) Patent Application Publication
(10) Pub. No.: US 2009/0318110 A1
(43) Pub. Date: Dec. 24, 2009

(54) METHOD AND APPARATUS FOR TRANSMISSION OF EMERGENCY MESSAGES

(75) Inventor: Kurt A. Zarefoss, Middletown, MD (US)

Correspondence Address: PRASS LLP, 2661 Riva Road, Bldg. 1000, Suite 1044, ANNAPOLIS, MD, 21401, US

(73) Assignee: LOCKHEED MARTIN CORPORATION, Bethesda, MD (US)

(21) Appl. No.: 12/144,035

(22) Filed: Jun. 23, 2008

(51) Int. Cl. H04M 11/04

(52) U.S. Cl. 455/404.2

(57) ABSTRACT

A method and apparatus that transmits emergency messages to communication devices is disclosed. The method may include receiving an emergency message from an emergency message authority to be broadcast to a particular geographic area, identifying the communication devices in the particular geographic area, and transmitting the received emergency message to the identified communication devices.

### BACKGROUND OF THE DISCLOSURE

1. Field of the Disclosure

The disclosure relates to a method and apparatus for transmission of emergency messages to communication devices.

2. Introduction

Most cellular phones provide the capability to send short text messages over the Short Message Service (SMS) protocol. This is a store a forward queuing mechanism which allows for the saving of messages that cannot be received by the destination phone immediately. Thus, this service creates a guaranteed quality of services between the sender and receiver. Since SMS based messages are supported by all of the major mobile technologies, such as Global System for Mobile Communications (GSM), Code Division Multiple Access (CDMA), and Time Division Multiple Access (TDMA), SMS messages is a global capability.

Another feature of cellular phones that has become more pervasive over the years is Global Positioning System (GPS) tracking capabilities. Although newer, smart phones provide GPS based mapping software, all cell phones manufactured after 2005 were required to support GPS tracking for the e911 (Emergency 911) calling feature. In addition, most SMS brokers used by the various cellular carriers have positional information within their message processors in order to relay text messages to the device.

### SUMMARY OF THE DISCLOSURE

A method and apparatus that transmits emergency messages to communication devices is disclosed. The method may include receiving an emergency message from an emergency message authority to be broadcast to a particular geographic area, identifying the communication devices in the particular geographic area, and transmitting the received emergency message to the identified communication devices.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is a diagram of an exemplary emergency message communication network environment in accordance with a possible embodiment of the disclosure;

FIG. 2 is a block diagram of an exemplary emergency message transmission server in accordance with a possible embodiment of the disclosure;

FIG. 3 is an exemplary flowchart illustrating a possible emergency message transmission process in accordance with one possible embodiment of the disclosure; and

FIG. 4 is a diagram of an exemplary emergency message broadcast area in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure may comprise a variety of embodiments, such as a method and apparatus and other embodiments that relate to the basic concepts of the disclosure. This disclosure may concern the dissemination of emergency information to constrained set of recipients based upon regional location (geospatial) and/or proximity to message originator. In combination, the messaging and communication device location technologies may provide a localized “push” mechanism for SMS-based text messaging, thereby constraining a broadcast message to a set of recipients based on their location. This process may prove to be a powerful tool in disseminating information in a variety of situations. Examples of the use include: homeland security, natural disaster, traffic emergencies, amber alert, medical assistance, emergency personal notification, or any other dangerous instance where notifying individuals of a situation is critical

There may be several options available in order to push a message to a set of users based on a regionally constrained set of parameters (e.g., location and range). These options may include:

GPS location information from the communication device

Proximity to a cell tower within a specified coverage area

Mobile Internet Protocol Version 6 (IPv6) connectivity

GPS Location Information: Since the introduction of the e911 support, more and more support for “broadcast” location-based applications have surfaced. These include applications that show the proximity to friend/relatives and getting turn by turn directions, for example. This same information may be used to send an SMS message to a communication device within a specific geographic region.

Communication Tower Proximity: Since communication networks currently need to know the location of communication devices such as cell phones relative to a communication tower in order to send messages and route calls, this process may be a technical solution that may bring the process to life in the shortest time. Using communication towers may not be as accurate or provide an area as constrained as pure GPS location information, but they do lift concerns regarding privacy issues.

Mobile IPv6: Mobile IPv6 may be the most sophisticated mechanism and may provide the most promise. IPv6 provides for an “always connected” mode of communication between the communication device and the “service provider”. This connection is maintained even as the communication device moves between service nodes; creating a reliable mechanism for sending data packets. Although mobile IPv6 is in its infancy, the use of GPS data from the communication device may be used to assist in the “handoff” required to maintain the devices connectivity. Since this location information in inherent in the protocol, it exploitation for the purpose of this disclosure are clear. That aside, this protocol could also be used solely for payload, and combined with the proximity to service towers and/or simplistic communication devices, information may be broadcasted to geospatially constrained set of devices.

The ability to constrain messages within a geospatially localized area may be provided by any of the mechanisms above. These options should not be considered mutually exclusive, and as privacy laws mature, may make using pure GPS location information more applicable.

The distribution of emergency messages from the source to various target communication service subscribers based on their location may be termed a GPS-based Emergency Message System (GEMS). In operation, once a message is sent, target devices may be identified via public location mechanisms, such as e911 or via carrier protocols/interfaces that are exposed for system consumption. This process may include the identification of relevant communication towers within a specified region. Once the target set of communication devices have been identified, the message may be sent to each device. If the message is to be “re-sent” after some period of time, then the process would repeat. This process may be operated to send the messages only to devices that have recently entered the broadcast area, but those devices that have already been targeted are filtered out, for example. Alternatively, the process may be operated to re-send the message to all devices in the broadcast area, including devices that have recently entered the broadcast area, but those devices that have left the broadcast area are filtered out and are not sent the message, for example.

The process may provide a mechanism for authoring message from a centralized console accessible to various federal, state, local, or emergency agencies. Once authenticated a user may have several options depending on their security rights, including:

Author a new message

Manage messages currently in the system (change parameters, remove it, etc.)

Manage user accounts

Manage default settings.

The system may include several components that could expand in the future to provide additional features and/or support additional variations. The following subsystems may be included:

Locator Service: This service may use the source message information that was specified during message authoring to determine the target set of communication devices that should receive the SMS message. This process may require an interface to the SMS message broker and the Mobile Switching Center, or other Application Programming Interface (API) support from various wireless carriers. Additionally, the location information specified may be used to identify cellular towers in that area. The message could then be pushed through services in support of the towers identified instead of communication devices in that area.

Messaging Queue: The messaging queue may be a persistent queue (or some other persistent store), to hold the emergency message for re-broadcast if requested by the author, for example.

Message Broadcasting: This service may be responsible for actually communicating to the SMS Message Broker to initiate the send command to all recipients when a message is sent, or a message is re-sent based on the rules engine and/or message options, for example. This process may require agreements or API support from the major wireless carriers.

Rules Management: A repository of default parameters on an agency and/or user basis may be provided that may be used when an emergency message doesn't define some of the available message parameters, such as range, re-send, etc.

Since the system may be positioned in front of the traditional GSM SMS Gateway, it can perform all of the necessary pre-processing prior to being routed to the communications network. Once the authorized user authenticates, they may be able to provide the necessary information to initiate a broadcast message. These settings may include the targeted geographical area by city and state, zip code, latitude/longitude, or even Geographical Coding (GEOCODE). Other options that could be overridden from the Rules Management service may include the target area size (in miles or kilometers), a re-send timeframe, and number of re-send occurrences. In order to protect against intrusion and abuse, standard intrusion detection and monitor and manage practices may be used, including event logging, log analysis, and Simple Mail Transfer Protocol (SMTP) traps.

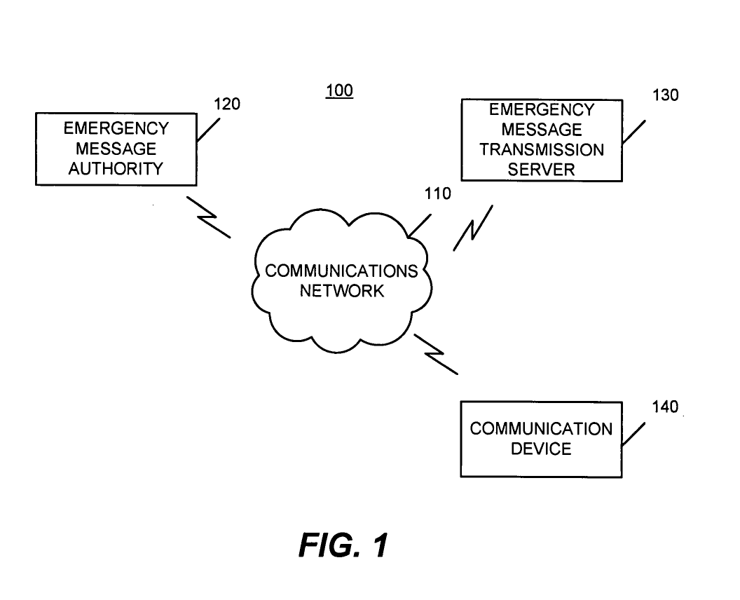

FIG. 1 is a diagram of an exemplary emergency message communication network environment 100 in accordance with a possible embodiment of the disclosure. In particular, although only one of each are shown for ease of discussion, the emergency message communication network environment 100 may include a plurality of communication devices 140, one or more emergency message transmission server 130, and one or more emergency message authority 120, connected through communications network 110.

Communications network 110 may represent any possible communications network that may handle telephonic communications, including wireless telephone networks, hardwired telephone networks, wireless local area networks (WLAN), the Internet, an intranet, etc., for example.

The one or more communication device 140 may represent any communication device, including a telephone, a cellular telephone, a mobile telephone, a wireless radio, a wireless telephone, a satellite radio receiver, an AM/FM radio receiver, a satellite television, a portable music player, a portable computer, a personal digital assistant PDA), a portable digital video recorder, a portable MP3 player, or combinations of the above, for example. Although only one communication device 140 is shown this is merely illustrative. There may be any number of communication devices 140 in the emergency message communication network environment 100.

The one or more emergency message transmission server 130 may represent a server, a computer, a personal computer, a portable computer, or a personal digital assistant, for example. An emergency message may be any message intended to warn or notify others of dangerous circumstances, such as homeland security issues, natural disasters, traffic emergencies, Amber alerts, medical assistance, emergency personal notification, or any other dangerous instance where notifying individuals of a situation is critical.

The one or more emergency message authority 120 may represent a centralized console accessible to various federal, state, local, or emergency agencies, such as police, fire, armed forces, National Guard, Coast Guard, Homeland Security, FBI, etc. In particular, the one or more emergency message authority 120 may represent a server, a computer, a personal computer, a portable computer, or a personal digital assistant at the emergency message authority 120 that may process information concerning emergencies and create emergency messages that may sent by the emergency message authority 120 to the emergency message transmission server 130 for eventual delivery to a user's communication device 140.

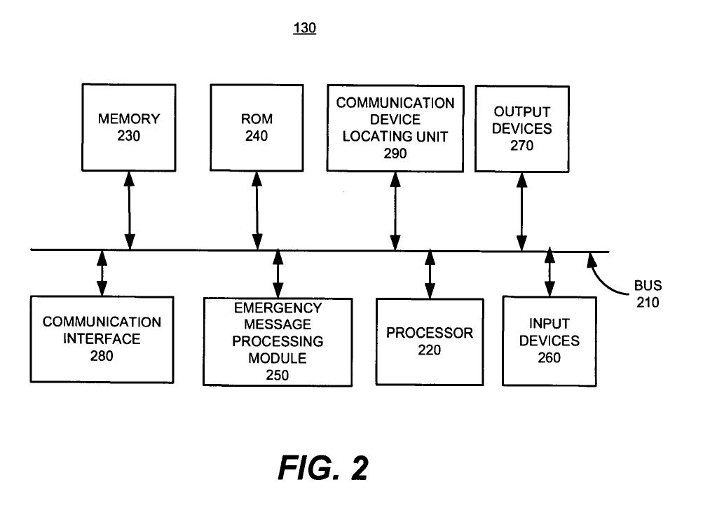

FIG. 2 is a block diagram of an exemplary emergency message transmission server 130 in accordance with a possible embodiment of the disclosure. The emergency message transmission server 130 may include may include bus 210, processor 220, memory 230, read only memory (ROM) 240, emergency message processing module 250, input devices 260, output devices 270, communication interface 280, and communication device locating unit 290. Bus 210 may permit communication among the components of the emergency message transmission server 130.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

Input devices 260 may include one or more conventional mechanisms that permit a user to input information to the emergency message transmission server 130, such as a keyboard, a mouse, a pen, a voice recognition device, touchpad, buttons, etc. Output devices 270 may include one or more conventional mechanisms that output information to the user, including a display, a printer, a copier, a scanner, a multi-function device, one or more speakers, or a medium, such as a memory, or a magnetic or optical disk and a corresponding disk drive.

The communication device locating unit 290 may receive information from one or more communication networks, communication towers, GPS satellites and relay stations that may permit the communication device locating unit 290 to locate communication devices in a particular geographic area.

The emergency message transmission server 130 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The emergency message transmission server 130 illustrated in FIGS. 1 and 2 and the related discussion are intended to provide a brief, general description of a suitable communication and processing environment in which the invention may be implemented. Although not required, the invention will be described, at least in part, in the general context of computer-executable instructions, such as program modules, being executed by the emergency message transmission server 130, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including personal computers, hand-held devices, multi-processor systems, microprocessor-based or programmable consumer electronics, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

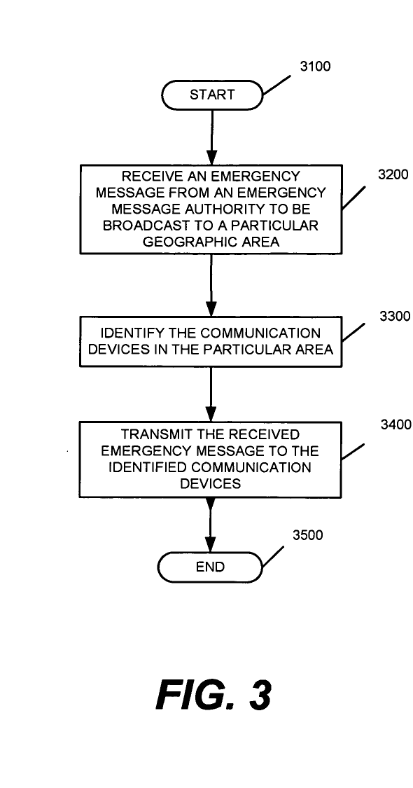

For illustrative purposes, the operation of the emergency message transmission server 130, the emergency message processing module 250, the communication device locating unit 290, and the emergency message transmission process are described in FIG. 3 in relation to the diagrams shown in FIGS. 1 and 2.

FIG. 3 is an exemplary flowchart illustrating a possible emergency message transmission process in accordance with one possible embodiment of the disclosure. The process begins at step 3100 and continues to step 3200 where the emergency message processing module 250 may receive an emergency message from an emergency message authority to be broadcast to a particular geographic area. The received emergency message may be in any form (e.g., electronic document, fax, text, e-mail, voice, etc.) and then converted by the emergency message processing module 250 into an SMS or e-mail format, for example.

At step 3300, the communication device locating unit 290 may identify the communication devices 140 in the particular geographic area. In this manner, the communication device locating unit 290 may locate the communication devices in the particular geographic area using received global positioning system information, cellular tower communications, or mobile IPv6 communications, for example.

At step 3400, the emergency message processing module 250 may transmit the received emergency message through the communication interface 260 to the identified communication devices 140. The emergency message may be transmitted in the form or an SMS (text) message to communication devices such as mobile phones, or e-mail messages to smartphones or PDAs have an e-mail (data) service. The process may then go to step 3500 and end.

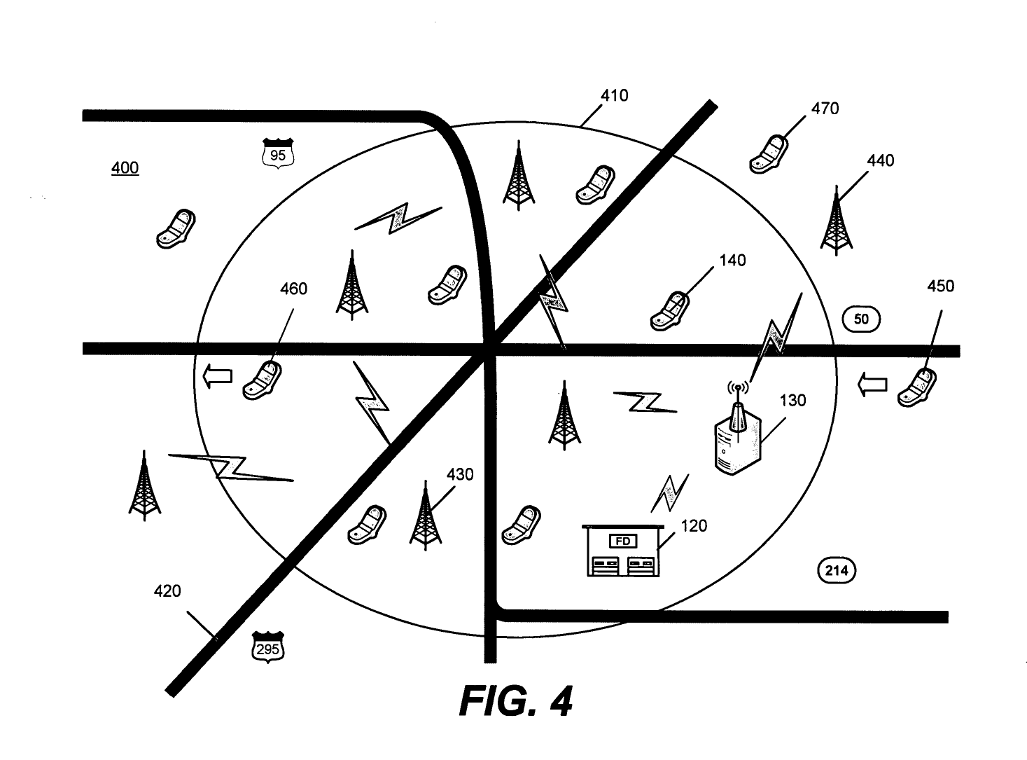

FIG. 4 is a diagram of an exemplary emergency message broadcast environment 400 in accordance with a possible embodiment of the disclosure. The emergency message broadcast environment 400 may include multiple roads 420 and other natural and manmade objects, one or more emergency message authorities 120, one or more emergency message servers 130, a plurality of communication devices 140, and a plurality of communication towers 430. For example, an emergency message authority 120 may send an emergency message to an emergency message server 130 for transmission only to a plurality of communication devices 140 in a particular geographic area 410. The communication device locating unit 290 may locate the communication devices 140 in the particular geographic area 410 using GPS, mobile IPv6, communication towers 430, etc. for example. Then, the emergency message processing module 250 may transmit the emergency message to the communication devices 140. The emergency messages may be relayed using several communication towers 430 in the particular geographic area 410 and communication towers 440 outside the particular geographic area 410, for example.

Note that communication devices 470 outside the particular geographic area 410 do not receive the emergency message. In addition, if the emergency message is set to be re-transmitted after a certain period of time, the communication device locating unit 290 may identify the communication device 450 as entering the particular geographic area 410 and the emergency message processing module 250 may send the re-transmission to the communication device 450 once it has entered the particular geographic area 410. Conversely, the communication device locating unit 290 may identify communication devices 460 as leaving the particular geographic area 410 and the emergency message processing module 250 may not send the re-transmission to the communication device 460 once it has left the particular geographic area 410.

Alternatively, on re-transmission, the emergency message processing module 250 may filter the transmission so that only communication devices that have not received the transmission will receive the re-transmission in the particular geographic area 410.

A “Response” service may be added to this process that can handle replies to the emergency message from recipients. This feature may be used to help emergency personnel understand situations as they unfold and take corrective action. Complimentary to creating a “Response” engine may be to allow the triggering of an emergency message via an SMS message sent to the emergency message transmission server from 130 by a registered and authorized user. This feature may allow for more immediate notification from emergency personnel that may be on-scene.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components of the disclosure each processing the content in various possible ways. It does not necessarily need to be one system used by all end users. Accordingly, the appended claims and their legal equivalents should only define the disclosure, rather than any specific examples given.

We claim:

1. A method for transmitting emergency messages to communication devices, comprising:
receiving an emergency message from an emergency message authority to be broadcast to a particular geographic area;
identifying the communication devices in the particular geographic area; and
transmitting the received emergency message to the identified communication devices.

2. The method of claim 1, further comprising:
setting a timer after the transmission of the received emergency message;
determining if the timer has expired, wherein if the timer has expired, identifying the communication devices in the particular geographic area; and
transmitting the received emergency message to the identified communication devices, wherein communication devices that have left the particular geographic area no longer receive the received emergency message and the communication devices that have entered the particular geographic area begin to receive the received emergency message.

3. The method of claim 1, further comprising:
identifying communication devices that have entered the particular geographic area;
transmitting the received emergency message to the entering communication devices.

4. The method of claim 1, further comprising:
identifying communication devices that have left the particular geographic area, wherein the received emergency message is not transmitted to the communication devices once they have left the particular geographic area.

5. The method of claim 1, wherein identification of communication devices within the particular geographic area is performed by receiving at least one of global positioning system information, cellular tower communications, and mobile Internet Protocol Version 6 communications.

6. The method of claim 1, wherein the received emergency message is transmitted by one of a short-message service message and an e-mail message.

7. The method of claim 1, wherein the method is performed by one of a server, a computer, a personal computer, a portable computer, and a personal digital assistant.

8. An emergency message transmission server that transmits emergency messages to communication devices, comprising:
a communication interface;
an emergency message processing module that receives an emergency message from an emergency message authority to be broadcast to a particular geographic area;
a communication device locating unit that identifies the communication devices in the particular geographic area, wherein the emergency message processing module transmits the received emergency message through the communication interface to the identified communication devices.

9. The emergency message transmission server of claim 8, wherein the emergency message processing module sets a timer after the transmission of the received emergency message, determines if the timer has expired, wherein if the emergency message processing module determines that the timer has expired, the communication device locating unit identifies the communication devices in the particular geographic area, and the emergency message processing module transmits the received emergency message to the identified communication devices, wherein the emergency message processing module does not transmit the received emergency message to communication devices that have left the particular geographic area and transmits the emergency message to communication devices that have entered the particular geographic area.

10. The emergency message transmission server of claim 8, wherein the communication device locating unit identifies communication devices that have entered the particular geographic area and the emergency message transmission module transmits the received emergency message to the entering communication devices.

11. The emergency message transmission server of claim 8, wherein the communication device locating unit identifies communication devices that have left the particular geographic area, wherein the emergency message transmission module does not transmit the emergency message to the communication devices that have left the particular geographic area.

12. The emergency message transmission server of claim 8, wherein the communication device locating unit identifies communication devices within the particular geographic area by receiving at least one of global positioning system information, cellular tower communications, and mobile Internet Protocol Version 6 communications.

13. The emergency message transmission server of claim 8, wherein the emergency message transmission module transmits the received emergency message by one of a short-message service message and an e-mail message.

14. The emergency message transmission server of claim 8, wherein the emergency message transmission server is one of a server, a computer, a personal computer, a portable computer, and a personal digital assistant.

15. A computer-readable medium storing instructions for controlling a computing device for transmitting emergency messages to communication devices, the instructions comprising:
receiving an emergency message from an emergency message authority to be broadcast to a particular geographic area;
identifying the communication devices in the particular geographic area; and
transmitting the received emergency message to the identified communication devices.

16. The computer-readable medium of claim 15, further comprising:
setting a timer after the transmission of the received emergency message;
determining if the timer has expired, wherein if the timer has expired, identifying the communication devices in the particular geographic area; and
transmitting the received emergency message to the identified communication devices, wherein communication devices that have left the particular geographic area no longer receive the received emergency message and the communication devices that have entered the particular geographic area begin to receive the received emergency message.

17. The computer-readable medium of claim 15, further comprising:
identifying communication devices that have entered the particular geographic area;
transmitting the received emergency message to the entering communication devices.

18. The computer-readable medium of claim 15, further comprising:
identifying communication devices that have left the particular geographic area, wherein the received emergency message is not transmitted to the communication devices once they have left the particular geographic area.

19. The computer-readable medium of claim 15, wherein identification of communication devices within the particular geographic area is performed by receiving at least one of global positioning system information, cellular tower communications, and mobile Internet Protocol Version 6 communications.

20. The computer-readable medium of claim 15, wherein the received emergency message is transmitted by one of a short-message service message and an e-mail message.

21. The computer-readable medium of claim 15, wherein the computer readable medium is coupled to a server, a computer, a personal computer, a portable computer, and a personal digital assistant.
